(19) United States
(12) Patent Application Publication
(10) Pub. No.: US 2003/0065819 A1
(43) Pub. Date: Apr. 3, 2003

(54) Dedicated content extraction algorithms and dynamic content allocation (DCA)

(76) Inventor: Prasad Seshdri, Cupertino, CA (US)

Correspondence Address: PRASAD SESHDRI, 10214, PARKWOOD DR., #4, CUPERTINO, CA, 95014, US

(21) Appl. No.: 09/970,467

(22) Filed: Oct. 3, 2001

(51) Int. Cl. G06F 15/16

(52) U.S. Cl. 709/246; 709/230; 709/217

(57) ABSTRACT

Mobile users can access the internet using the cellular network at a baud-rate of approximately 14.4 kbits/s. This baud rate is too slow for acceptable download time since the source code for most web pages have an average of 50 kilobytes of data. This technology pertains to extracting only the most important data from the web pages and parceling the data in smaller packets so that the download time is always acceptable. If the data rate is subsequently enhanced by improvements in cellular infrastructure, them the size of the parcels will be increased to be able to send more content with the same download time.

### FIELD OF INNOVATION

The presentation is related to internet access though non-standard web-access devices. The technology described below enables users to access the web using non-standard web access devices like TV, mobile laptops, Windows CE devices, PDA's etc without the web-page developer having to rewrite the web pages for each non-standard web-access device (NSWAD). For mobile users, this technology relates to accessing the internet by using the existing cellular networks at acceptable page download rates.

### BACKGROUND

Currently manufacturers who offer web-services on non-standard web-access devices are faced with a problem. Content developers have to decide to support the formatting constraints of the non-standard device. If they do support the NSWAD (non-standard web-access device), they run into logistic problems. They have to maintain more than one version of their web page. For sites with rapidly changing contents, this becomes a major problem-maintaining multiple versions of their web pages as well as ensuring that the contents on the different versions are consistent. In addition, this difficulty in producing content for non-standard devices restricts the manufacturers from introducing other interesting format for access devices that may have a better chance of success in the market.

### SUMMARY AND ADVANTAGES

We think it is possible to get away from all the constraints placed by data formatting by developing a server that automatically separates the content on a web page from its format.

The way the system would work would be for the NSWAD to request a URL from the server. The server gets the web page from the URL requested, it extracts the links, the content and the input from the web page and reformats it to fit the NSWAD.

The advantage of such a system is that the source URL need not bother about the formatting considerations of the NSWAD and the NSWAD does not have to conform himself to a restrictive format in designing their devices. They will be free to experiment with the market acceptability of varied designs of formats.

### DRAWING

FIG. 1: Shows how the idea behind inFormat works.

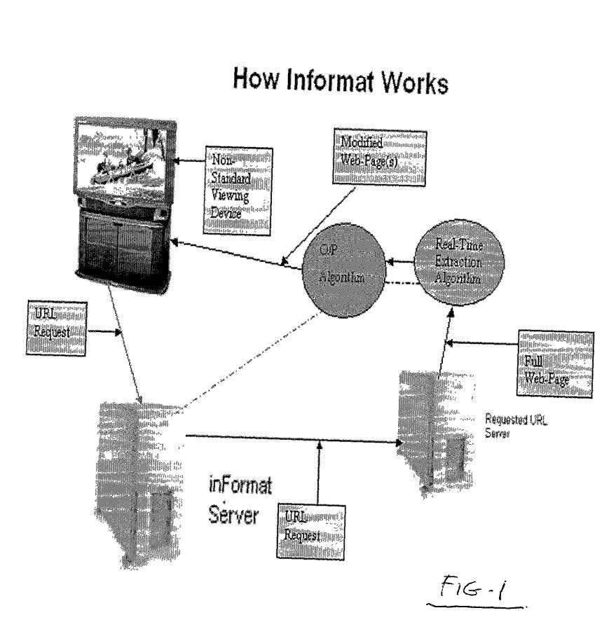

### DETAIL DESCRIPTION OF IN FORMAT

This is how inFormat would work:

1) The user requests a web page from a URL from a NSWAD device.

2) The request is transmitted to an inFormat server.

3) The inFormat server passes the request to the web page host.

4) The web page host responds to the inFormat server with the web page.

5) The inFormat server uses parsing algorithms to parse the web page into its simple constituents: links, content and input boxes. It does so in real time and formats it appropriate to a requesting device.

6) The inFormat server parses and reformats the data sent to the NSWAD.

7) Conversely, inFormat server passes on any selections or inputs from the NSWAD to the source web page.

1. What is patentable about this technology:
a) Most competing technologies offer such algorithmic separation and formatting as a part of their browser which is located on the NSWAD. In doing so, they receive the unmodified source code from the web-site being browsed and do the extraction and rendering of data on the NSWAD screen by having a general purpose algorithm to do so. Where the degree of translation is severe, as in the case of phone based screens, the source code needs to be modified at the web-site.
Our approach differs in the following ways:
a) We send the original source our the server before sending a modified source to the viewing device.
b) We have site based dedicated algorithms to extract data and reformat the data for viewing devices. The advantage is that both the extraction of site data as well as the presentation of extracted data will be more elegant on the NSWAD screen. In addition, the source sent to NSWAD can be modified to ensure optimal page download time as will be seen below.
This routing of web page source code through a server and modifying it on the fly is unique and patentable. Advantage of this is that no changes need to be made both on the web content end and the viewing device end and all the sites supported by a library of algorithms on our server will be capable of being viewed perfectly, with acceptable download times anywhere in the cellular network. Disadvantage is that the browsing works only with those web-sites supported by our algorithms.
b) Dedicated Extraction Algorithms (DEA):
Since most web sites use tools to modify the contents, dedicated algorithms can be written for each site, which act like reverse tools, to extract the various elements of a web site—like links, contents, tables, input boxes, graphics etc. These dedicated extraction algorithms are patentable.
c) c) Dynamic Content Allocation (DCA):
The main problem encountered during browsing is the web-page download time. When the Internet connection speed is low—typically a baud rate of 14.4 kb/s when one connects to the Internet using existing cellular networks. When the user is connected to our inFormat server, it is possible for the server to sense what baud rate the user is connected it. It is possible to tailor the content sent to the user so that irrespective of the connection baud rate, the web page download time is kept more or less constant and acceptable. While surfing the web it is not the amount of information per page that determines acceptable surfing comfort but the page download time. So, if we were to reduce the amount of content on a page and achieve acceptable download time it would be more acceptable than having more content on a web page and a slow down load time. The Dedicated Extraction Algorithm described above fully parses a web page—so now it is possible to decide how much of the extracted information should be sent per page so that the page download time is acceptable. DCA can decide the manner in which to send elements that strain download time like graphics, table etc . . . so that as much information can be sent for a satisfactory browsing experience without causing an unacceptable deterioration of download time. This process of tailoring the amount of content to be delivered per page in order to maintain acceptable page download time—Dynamic Content Allocation—is patentable. The effect of DCA could be that one page of original content gets split into 3-4 pages of delivered content plus timming all the load causing elements from the original content resulting in 5-10 fold improvement in page load time.
